(19) United States
(12) Patent Application Publication
(10) Pub. No.: US 2026/0138423 A1
(43) Pub. Date: May 21, 2026

(54) VEHICLE SIDE PORTION STRUCTURE

(71) Applicant: TOYOTA JIDOSHA KABUSHIKI KAISHA, Toyota-shi (JP)

(72) Inventors: Tetsuo NURUKI, Toyota-shi (JP); Takehiro ITO, Nisshin-shi (JP); Norihiro MURASHIGE, Nisshin-shi (JP)

(73) Assignee: TOYOTA JIDOSHA KABUSHIKI KAISHA, Toyota-shi (JP)

(21) Appl. No.: 19/357,462

(22) Filed: Oct. 14, 2025

(30) Foreign Application Priority Data
Nov. 21, 2024 (JP) 2024-203257

(51) Int. Cl. B60J 5/04; B62D 21/02; B62D 21/15

(52) U.S. Cl. CPC B60J 5/0429; B62D 21/02; B62D 21/155; B62D 21/157

(57) ABSTRACT

A door impact beam is disposed in a rear side door that opens and closes a rear side door opening portion and extends along a vehicle front-rear direction. In addition, a part of the lower portion of the rear side frame portion that constitutes the rear side door opening portion is constituted by the lower-side frame portion. A rib provided on the lower-side frame portion is disposed at a position where a part of the rib overlaps an end portion of the door impact beam in a longitudinal direction in a vehicle side view, and is erected in a direction intersecting the longitudinal direction of the door impact beam in the vehicle side view.

### CROSS-REFERENCE TO RELATED APPLICATION

This application claims priority to Japanese Patent Application No. 2024-203257 filed on Nov. 21, 2024. The disclosure of the above-identified application, including the specification, drawings, and claims, is incorporated by reference herein in its entirety.

### BACKGROUND

### 1. Technical Field

The present disclosure relates to a vehicle side portion structure.

### 2. Description of Related Art

A structure in which a door impact beam is provided inside a side door in a vehicle side portion is known (for example, see Japanese Unexamined Patent Application Publication No. 2009-227064 (JP 2009-227064 A) and Japanese Unexamined Patent Application Publication No. 9-86178 (JP 9-86178 A)).

### SUMMARY

However, there is room for improvement in restraining the door impact beam from moving toward a vehicle cabin inner side at the time of side collision.

In view of the above fact, an object of the present disclosure is to obtain a vehicle side portion structure capable of restraining a door impact beam from moving toward a vehicle cabin inner side at the time of side collision.

A vehicle side portion structure according to a first aspect includes a door impact beam disposed in a rear side door that opens and closes a rear side door opening portion, the door impact beam extending along a vehicle front-rear direction, a lower-side frame portion constituting at least a part of a lower portion of a rear side frame portion that constitutes the rear side door opening portion, and
a rib provided on the lower-side frame portion, disposed at a position where at least a part of the rib overlaps an end portion of the door impact beam in a longitudinal direction in a vehicle side view, and erected in a direction intersecting the longitudinal direction of the door impact beam in the vehicle side view.

In addition, the concept of “extending along the vehicle front-rear direction” includes a case of extending in the vehicle front-rear direction, as well as a case of extending to be inclined to one side in the vehicle up-down direction toward the vehicle rear side and being able to be recognized as extending along the vehicle front-rear direction.

With the vehicle side portion structure according to the first aspect, the door impact beam is disposed in the rear side door that opens and closes the rear side door opening portion, and extends along the vehicle front-rear direction. In addition, at least the part of the lower portion of the rear side frame portion that constitutes the rear side door opening portion is constituted by the lower-side frame portion. Here, the rib provided on the lower-side frame portion is disposed at the position where at least the part of the rib overlaps the end portion of the door impact beam in the longitudinal direction in the vehicle side view, and is erected in the direction intersecting the longitudinal direction of the door impact beam in the vehicle side view. Therefore, in a case where a collision load is input to the rear side door at the time of side collision, a part of the collision load is efficiently transmitted from the door impact beam side to the lower-side frame portion side through the rib. Therefore, movement of the door impact beam to the vehicle cabin inner side can be restrained.

In the vehicle side portion structure according to a second aspect, in the configuration according to the first aspect,
a cross member extending along a vehicle width direction is connected to an inner side of the lower-side frame portion in the vehicle width direction, and
the rib extends toward the cross member in a vehicle plan view.

With the vehicle side portion structure according to the second aspect, the rib extends toward the cross member in the vehicle plan view. Therefore, in a case where the collision load is input to the rear side door at the time of the side collision, a part of the collision load is transmitted from the door impact beam side to the cross member side through the rib and the lower-side frame portion. Therefore, the collision load can be more favorably transmitted, and it is possible to effectively restrain the door impact beam from moving toward the vehicle cabin inner side.

In the vehicle side portion structure according to a third aspect, in the configuration according to the first or second aspect,
the lower-side frame portion, the rib, and a rear wheel house portion provided rearward of the lower-side frame portion in the vehicle front-rear direction are integrally provided by die casting.

With the vehicle side portion structure according to the third aspect, in a case where the collision load is input to the rear side door at the time of the side collision, it is possible to efficiently share a part of the load with the rear wheel house portion. The load is a load transmitted from the door impact beam side to the lower-side frame portion side through the rib.

As described above, with the vehicle side portion structure according to the present disclosure, an excellent effect of restraining the door impact beam from moving toward the vehicle cabin inner side at the time of the side collision can be obtained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a rear frame body applied to a vehicle side portion structure according to an embodiment;

FIG. 2 is a side view showing a positional relationship between a rear portion and the like of a door impact beam and a part of the rear frame body with a side door body portion and the like in a state of being seen through;

FIG. 3 is a side view showing a part of a rear side of a vehicle in a vehicle front-rear direction to which the vehicle side portion structure according to the embodiment is applied; and

FIG. 4 is an enlarged sectional view cut along the line 4-4 in FIG. 3.

### DETAILED DESCRIPTION OF EMBODIMENTS

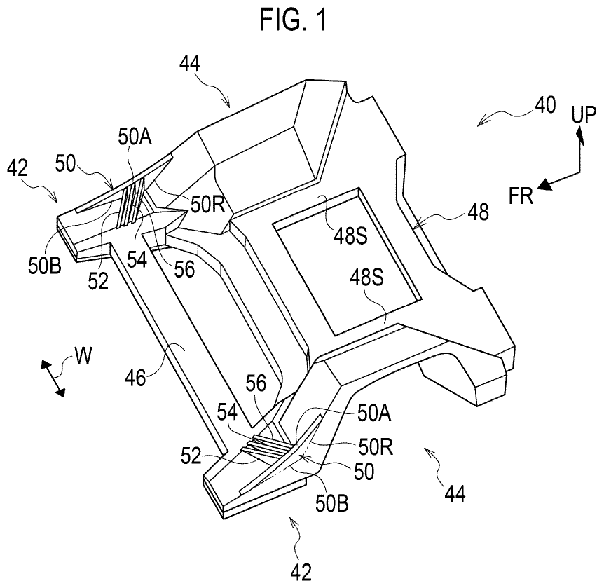

A vehicle side portion structure according to an embodiment of the present disclosure will be described with reference to FIGS. 1 to 4. In FIGS. 1 to 4, an arrow FR shown as appropriate indicates a vehicle front side, an arrow UP indicates a vehicle upper side, an arrow W indicates a vehicle width direction, and an arrow IN indicates an inner side of the vehicle width direction.

### Configuration of Embodiment

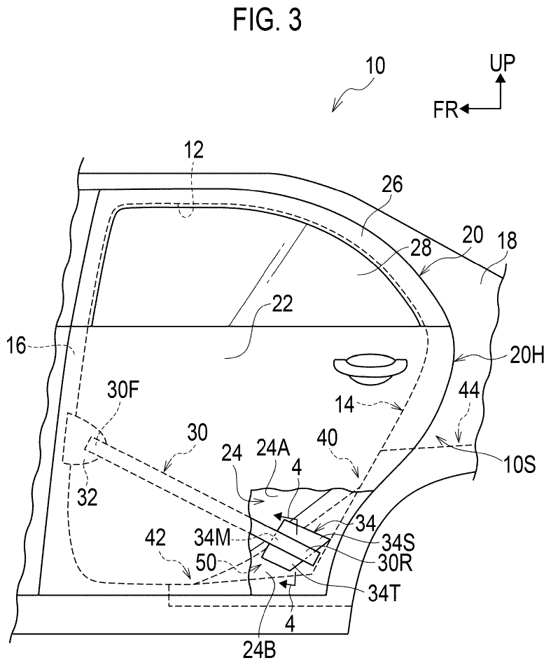

FIG. 3 shows a side view of a part of a rear side of a vehicle 10 in a vehicle front-rear direction to which a vehicle side portion structure according to the present embodiment is applied. As shown in FIG. 3, a rear side door opening portion 12 is provided on a rear side of a vehicle side portion 10S. The rear side door opening portion 12 communicates the inside of the vehicle cabin with the outside of the vehicle cabin, and is opened and closed by the rear side door 20. An outer surface of the vehicle 10 on an outer side of the vehicle width direction is constituted by a vehicle body outer panel 18.

The rear side door 20 is disposed on the vehicle side portion 10S and includes a side door body portion 20H as a body portion. As an example in the present embodiment, the side door body portion 20H is attached to a center pillar 16 that constitutes a part of the vehicle body by a door hinge (not shown), and is rotatable around a hinge pin of the door hinge. In the present embodiment, the rear side door 20 constitutes a so-called swing-type side door, but may constitute a so-called slide-type side door.

The side door body portion 20H includes a door outer panel 22 made of a metal (for example, steel) that is disposed on the outer side in the vehicle width direction in a door closed state and constitutes a door outer panel portion. A door inner panel 24 made of the metal (for example, steel) is disposed on the inner side of the door outer panel 22 in the vehicle width direction in the door closed state. In FIG. 3, a part of the door outer panel 22 is cut out to show the door inner panel 24. The door inner panel 24 constitutes a door inner panel portion of the side door body portion 20H.

A bulging portion 24A that bulges toward the vehicle cabin side and accommodates a window regulator (not shown) or the like is provided in the central portion of the door inner panel 24. In addition, in the door inner panel 24, a shelf portion 24B disposed in a substantially vehicle width direction as a plate thickness direction is formed on both sides in the vehicle front-rear direction and a vehicle lower side with respect to the bulging portion 24A. Edge portions of the door inner panel 24 on both sides in the vehicle front-rear direction and the vehicle lower side are joined to edge portions of the door outer panel 22 on both sides in the vehicle front-rear direction and the vehicle lower side by hemming. As a result, the side door body portion 20H having a bag shape in which an upper edge portion is opened is constituted by integrating the door outer panel 22 and the door inner panel 24.

In addition, a door window frame 26 of a frame-shaped body is provided on a vehicle upper side of the door outer panel 22. A windshield (side glass) 28 being able to appear and disappear from the side door body portion 20H is disposed in the door window frame 26 to be capable of being raised and lowered.

A door impact beam 30 extending along a vehicle front-rear direction is disposed in the side door body portion 20H of the rear side door 20. The door impact beam 30 of the present embodiment is slightly inclined toward the vehicle lower side toward the vehicle rear side in the vehicle side view. The door impact beam 30 is a member having high strength and high rigidity and is made of a member having a pipe shape.

A mounting bracket (also referred to as an “extension”) 32 as a bracket made of a sheet metal is fixed to a portion of a front end portion 30F that is one end portion of the door impact beam 30 in the longitudinal direction, on the inner side in the vehicle width direction by welding. The mounting bracket 32 is fixed to a portion of the shelf portion 24B of the door inner panel 24 on the vehicle front side by welding, bolt fastening, or the like. That is, the front end portion 30F of the door impact beam 30 is fixed to the side door body portion 20H of the rear side door 20 via the mounting bracket 32.

Further, a mounting bracket (also referred to as an “extension”) 34 as a bracket made of a sheet metal is fixed to a portion of a rear end portion 30R that is the other end portion of the door impact beam 30 in the longitudinal direction, on the inner side in the vehicle width direction by welding. The mounting bracket 34 is fixed to a portion of the shelf portion 24B of the door inner panel 24 on the vehicle rear side by welding, bolt fastening, or the like. That is, the rear end portion 30R of the door impact beam 30 is fixed to the side door body portion 20H of the rear side door 20 via the mounting bracket 34.

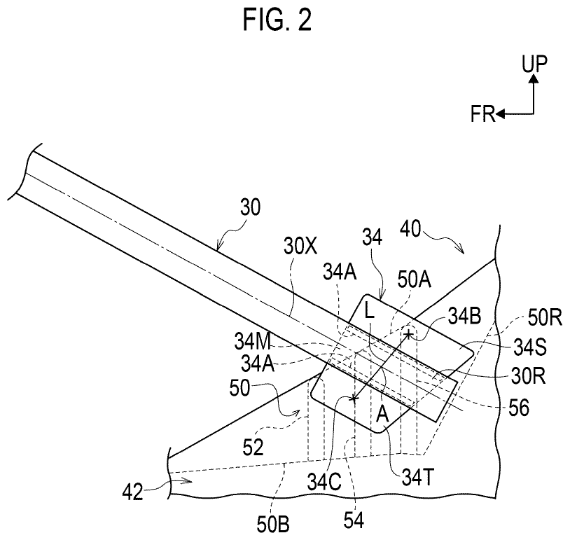

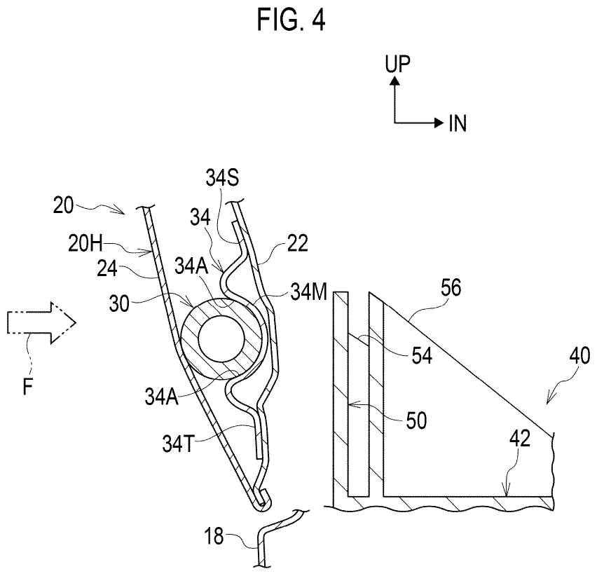

Here, the mounting bracket 34 will be described in more detail. The mounting bracket 34 includes a beam support portion 34M disposed at a position overlapping a part of the door impact beam 30 in the vehicle side view. FIG. 4 shows an enlarged sectional view cut along the line 4-4 in FIG. 3. In FIG. 4, for convenience, a portion of the vehicle body outer panel 18 that is disposed on the inner side in the vehicle width direction with respect to the rear side door 20 is not shown. As shown in FIG. 4, the beam support portion 34M is curved in an arc shape such that the surface on the door impact beam 30 side is curved along the outer peripheral surface of the door impact beam 30. The beam support portion 34M includes a first fixed portion 34A fixed to the door impact beam 30. A range of the first fixed portion 34A in the vehicle side view is shown in FIG. 2. As shown in FIGS. 3 and 4, the mounting bracket 34 includes side portions 34S, 34T that are disposed continuously with the beam support portion 34M on both sides of the door impact beam 30 in a direction intersecting the longitudinal direction (axial direction) in the vehicle side view. The side portions 34S, 34T include second fixed portions 34B, 34C (see FIG. 2 (in FIG. 2, for convenience, the positions of the second fixed portions 34B, 34C are indicated by “×”)) fixed to the side door body portion 20H of the rear side door 20.

As described above, the front end portion 30F and the rear end portion 30R of the door impact beam 30 are fixed to the side door body portion 20H of the rear side door 20 shown in FIG. 3. As a result, the rigidity of the side door body portion 20H of the rear side door 20 with respect to the load in the vehicle front-rear direction is improved.

A rear frame body 40 made by die casting is provided on a rear side of the vehicle side portion 10S. The rear frame body 40 includes a lower-side frame portion 42 and a rear wheel house portion 44 provided on the rear side of the lower-side frame portion 42 in the vehicle front-rear direction. The lower-side frame portion 42 constitutes a part of the lower portion (more specifically, a rear portion) of the rear side frame portion 14 that constitutes the rear side door opening portion 12.

FIG. 1 shows a perspective view of the rear frame body 40. In FIG. 1, the detailed shape of the rear frame body 40 is appropriately simplified. As shown in FIG. 1, the rear frame body 40 includes each of the lower-side frame portion 42 and the rear wheel house portion 44 on both sides in the vehicle width direction. The lower-side frame portion 42 extends along the vehicle front-rear direction. The rear wheel house portion 44 is provided continuously to the rear end portion side of the lower-side frame portion 42. In addition, the rear frame body 40 includes a cross member (also referred to as a cross member portion) 46 that connects the right and left lower-side frame portions 42 to each other in the vehicle width direction, and includes a connection frame portion 48 that connects the right and left rear wheel house portions 44 to each other in the vehicle width direction. The cross member 46 is provided in a beam shape, and is connected to the lower-side frame portion 42 and extends along the vehicle width direction. The connection frame portion 48 is provided in a frame shape in plan view, and the right and left side component portions 48S are continuous with the rear wheel house portion 44.

FIG. 2 is a side view (a view seen from the outer side in the vehicle width direction) showing a positional relationship between the rear portion of the door impact beam 30 and the mounting bracket 34 and a part of the rear frame body 40 with the side door body portion 20H (see FIG. 3) and the like in a state of being seen through. As shown in FIGS. 1 and 2, the rear frame body 40 includes a vertical wall portion 50 erected from the lower-side frame portion 42. As shown in FIG. 1, the vertical wall portion 50 is set to extend in the thickness direction along the vehicle width direction. A lower end portion 50B of the vertical wall portion 50 is continuous with the lower-side frame portion 42, and the rear end portion 50R of the vertical wall portion 50 is continuous with, for example, the rear wheel house portion 44. In addition, in the left side of the vehicle right-left direction in FIG. 1, each of the positions of the lower end portion 50B and the rear end portion 50R of the vertical wall portion 50 on the outer side surfaces in the vehicle width direction is shown by the two-dot chain line for convenience. An upper end surface 50A of the vertical wall portion 50 is inclined toward the vehicle lower side in the vehicle front side as an example.

As shown in FIG. 2, the vertical wall portion 50 is disposed at a position overlapping the rear end portion 30R (one of the end portions of the door impact beam 30 in the longitudinal direction) of the door impact beam 30 in the vehicle side view. In addition, the vertical wall portion 50 is disposed at a position overlapping a part of the mounting bracket 34 (more than half in the present embodiment) in the vehicle side view. In addition, the vertical wall portion 50 includes a portion overlapping an intersection A. The intersection A is an intersection of a center line 30X along the longitudinal direction of the door impact beam 30 and a line segment L in the vehicle side view. The line segment L is a line segment connecting the second fixed portion 34B of one side portion 34S and the second fixed portion 34C of the other side portion 34T of two side portions 34S, 34T of the mounting bracket 34.

As shown in FIGS. 1 and 2, a plurality of (three in the example) ribs 52, 54, 56 is provided on the lower-side frame portion 42 on the inner side of the vertical wall portion 50 in the vehicle width direction. In FIG. 2, the ribs 52, 54, 56 are shown by a broken line solely at the boundary with the vertical wall portion 50 in the ribs 52, 54, 56 for convenience. In the present embodiment, each of the ribs 52, 54, 56 is provided to be arranged in the vehicle front-rear direction on both the right and left sides of the rear frame body 40, and connect the vertical wall portion 50 and the lower-side frame portion 42. As shown in FIG. 1, the ribs 52, 54, 56 extend toward the cross member 46 in a vehicle plan view. In the present embodiment, the ribs 52, 54, 56 extend linearly from the vertical wall portion 50 side toward the front side obliquely inner side in the vehicle width direction. The ribs 52, 54, 56 are formed in a triangular shape, for example, as viewed from the vehicle front side, but may have another shape such as a square shape.

As shown in FIG. 2, the ribs 52, 54, 56 are erected in a direction intersecting the longitudinal direction of the door impact beam 30 in the vehicle side view. A part of each of the ribs 52, 54, 56 is disposed at a position overlapping the mounting bracket 34 in the vehicle side view. In addition, a part of the second rib 54 from the front and the rearmost rib 56 are disposed at a position overlapping the rear end portion 30R (one of the end portions of the door impact beam 30 in the longitudinal direction) of the door impact beam 30 in the vehicle side view. As a modification of the present embodiment, for example, the height of the front portion of the vertical wall portion 50 may be higher than the height shown in FIG. 2, and the height of the frontmost rib 52 in the vertical direction may be increased. In this case, a part of the frontmost rib 52 may be disposed at a position overlapping the rear end portion 30R of the door impact beam 30 in the vehicle side view.

In addition, in the present embodiment, the second rib 54 from the front and the rearmost rib 56 include a portion that overlaps the line segment L connecting one second fixed portion 34B and the other second fixed portion 34C of the mounting bracket 34 in the vehicle side view. Further, in the present embodiment, the second rib 54 from the front is set closer to the vehicle front side than the intersection A of the center line 30X and the line segment L along the longitudinal direction of the door impact beam 30 in the vehicle side view. The rearmost rib 56 is set on the vehicle rear side than the intersection A of the center line 30X and the line segment L along the longitudinal direction of the door impact beam 30 in the vehicle side view.

The lower-side frame portion 42, the cross member 46, the vertical wall portion 50, the ribs 52, 54, 56, the rear wheel house portion 44, and the connection frame portion 48 shown in FIG. 1 are integrally formed by die casting of a metal material (for example, a light metal material such as an aluminum alloy material). The rear frame body 40 is a member that can be recognized as a rear side gigacast.

### Action and Effect of Embodiment

Next, action and effect of the present embodiment will be described.

In the present embodiment, as shown in FIG. 3, the door impact beam 30 is disposed in the rear side door 20 and extends along the vehicle front-rear direction. In addition, a part of the lower portion of the rear side frame portion 14 that constitutes the rear side door opening portion 12 is constituted by the lower-side frame portion 42. Here, as shown in FIG. 2, a part of the ribs 54, 56 are disposed at a position overlapping the rear end portion 30R of the door impact beam 30 overlaps in the vehicle side view and are erected in a direction intersecting the longitudinal direction of the door impact beam 30 in the vehicle side view. Here, the ribs 54, 56 are provided in the lower-side frame portion 42. At the time of the side collision, the collision load F may be input to the rear side door 20 shown in FIG. 4. In this case, since a part of the collision load F is efficiently transmitted from the door impact beam 30 to the lower-side frame portion 42 through the ribs 54, 56, the movement of the door impact beam 30 to the vehicle cabin side can be restrained.

In addition, in the present embodiment, as shown in FIG. 1, the cross member 46 connected to the lower-side frame portion 42 on the inner side in the vehicle width direction is extended along the vehicle width direction, and the ribs 54, 56 are extended toward the cross member 46 in the vehicle plan view. At the time of the side collision, the collision load may be input to the rear side door 20 shown in FIG. 3. In this case, a part of the collision load is transmitted from the door impact beam 30 side to the cross member 46 side shown in FIG. 1 through the lower-side frame portion 42 via the ribs 54, 56 shown in FIG. 2. Therefore, the collision load can be more favorably transmitted, and it is possible to effectively restrain the door impact beam 30 shown in FIG. 3 from moving toward the vehicle cabin side.

In addition, in the present embodiment, the lower-side frame portion 42, the ribs 54, 56, and the rear wheel house portion 44 shown in FIG. 1 are integrally formed by die casting. At the time of the side collision, the collision load may be input to the rear side door 20 (see FIG. 3). In this case, it is possible to efficiently share a part of the load transmitted from the door impact beam 30 to the lower-side frame portion 42 side through the ribs 54, 56 with the rear wheel house portion 44.

As described above, with the vehicle side portion structure according to the present embodiment, it is possible to restrain the door impact beam 30 shown in FIG. 3 and the like from moving toward the vehicle cabin side at the time of the side collision. Supplemental Description of Embodiment

In the embodiment shown in FIGS. 1 to 4, the lower-side frame portion 42 constitutes a lower portion of the rear side frame portion 14 that constitutes the rear side door opening portion 12. As a modification of the embodiment, the lower-side frame portion may constitute the entire lower portion of the rear side frame portion (14) that constitutes the rear side door opening portion (12). In addition, there is a modification in which the lower-side frame portion constitutes the entire lower portion of the rear side frame portion (14) that constitutes the rear side door opening portion (12). In the modification, the lower-side frame portion may have a configuration in which the lower-side frame portion is disposed at a position where the front end portion of the door impact beam and at least a part of the door impact beam overlap with each other in the vehicle side view and the lower-side frame portion has the rib erected in the direction intersecting the longitudinal direction of the door impact beam in the vehicle side view.

In addition, as the modification of the embodiment, a configuration in which one or three or more ribs that function in the same manner as the ribs 54, 56 of the embodiment are provided in each of right and left lower-side frame portions (42) can be adopted. The rib that functions in the same manner as the ribs 54, 56 of the embodiment is, in other words, a rib that is disposed at a position where the longitudinal end portion of the door impact beam (30) and at least a part of the rib overlap each other in the vehicle side view and is erected in the direction intersecting the longitudinal direction of the door impact beam (30) in the vehicle side view.

In addition, in the embodiment, the ribs 54, 56 are disposed at a position where a part of the rear end portion 30R of the door impact beam 30 overlaps in the vehicle side view. As the modification of the embodiment, a configuration in which all the ribs are disposed at a position overlapping the end portion of the door impact beam in the longitudinal direction in the vehicle side view can also be adopted. All of the ribs are provided in the lower-side frame portion and are all of the ribs erected in the direction intersecting the longitudinal direction of the door impact beam in the vehicle side view.

In addition, in the embodiment, the ribs 54, 56 extend toward the cross member 46 in the vehicle plan view. As the modification of the embodiment, a configuration in which a rib is disposed at a position provided in the lower-side frame portion (42) and overlaps at least a part of the end portion of the door impact beam (30) in the longitudinal direction in the vehicle side view, and the rib is erected in the direction intersecting the longitudinal direction of the door impact beam (30) in the vehicle side view such that the rib does not extend toward the cross member (46) in the vehicle plan view can be adopted.

In addition, the embodiment, the lower-side frame portion 42, the ribs 54, 56, and the rear wheel house portion 44 are integrally formed by die casting, and such a configuration is preferable. As the modification of the embodiment, a configuration in which the lower-side frame portion (42) and the ribs (54, 56) are integrally formed, and the rear wheel house portion provided separately from the integrally formed portion is joined to the lower-side frame portion (42) can be adopted.

In addition, in the embodiment, the rear frame body 40 includes the vertical wall portion 50 erected from the lower-side frame portion 42, but a configuration in which the vertical wall portion 50 is not provided can also be adopted.

In addition, in the embodiment, the lower-side frame portion 42 and the cross member 46 are integrally formed, and such a configuration is preferable. As the modification of the embodiment, a configuration in which the cross member separately provided from the lower-side frame portion 42 is joined to the lower-side frame portion (42) can also be adopted.

The embodiments and the modifications can be appropriately combined and implemented.

Although an example of the present disclosure has been described above, the present disclosure is not limited to the above, and can be variously modified and implemented within the scope not deviating the spirit of the present disclosure.

What is claimed is:

1. A vehicle side portion structure comprising:
a door impact beam disposed in a rear side door that opens and closes a rear side door opening portion, the door impact beam extending along a vehicle front-rear direction;
a lower-side frame portion constituting at least a part of a lower portion of a rear side frame portion that constitutes the rear side door opening portion; and
a rib provided on the lower-side frame portion, disposed at a position where at least a part of the rib overlaps an end portion of the door impact beam in a longitudinal direction in a vehicle side view, and erected in a direction intersecting the longitudinal direction of the door impact beam in the vehicle side view.

2. The vehicle side portion structure according to claim 1, wherein:
a cross member extending along a vehicle width direction is connected to an inner side of the lower-side frame portion in the vehicle width direction; and
the rib extends toward the cross member in a vehicle plan view.

3. The vehicle side portion structure according to claim 1, wherein the lower-side frame portion, the rib, and a rear wheel house portion provided rearward of the lower-side frame portion in the vehicle front-rear direction are integrally provided by die casting.
